(19) United States
(12) Patent Application Publication
(10) Pub. No.: US 2026/0189571 A1
(43) Pub. Date: Jul. 2, 2026

(54) Hierarchical Cloud-Based Resource Identifier and Access Management System for Distributed Multi-tenant Data

(71) Applicant: Progress Software Corporation, Burlington, MA (US)

(72) Inventors: Andy Berryman, Holly Springs, NC (US); Andrew Phillips, Raleigh, NC (US); Dustin Norman, Apex, NC (US); Eric Davis, Morrisville, NC (US); Grahame Murray, Raleigh, NC (US); John Morris, Holly Springs, NC (US); Kristopher Tyra, Raleigh, NC (US); Nikita Nuka, Santa Clara, CA (US); Ryan Jensen, Fuquay Varina, NC (US); Spencer Langley, Beloit, WI (US); Zachariah Jeyakaran, Lafayette, CO (US); Justin Bay, Raleigh, NC (US)

(21) Appl. No.: 19/436,357

(22) Filed: Dec. 30, 2025

Related U.S. Application Data
(60) Provisional application No. 63/740,129, filed on Dec. 30, 2024.

(51) Int. Cl. H04L 9/40

(52) U.S. Cl. CPC H04L 63/105; H04L 63/102

(57) ABSTRACT

A system and method for receiving an authorization request, the authorization request including a first resource identifier including one or more path segments; processing the resource identifier uniquely identifying a set of resources in the microservice environment by: (a) determining whether a set of permissions is associated with the resource identifier is present in a resource access manager; (b) recording the set of permissions when present; (c) decatenating an end path segment from the resource identifier based on a delimiter; and (d) determining whether no path segments remain in the resource identifier after decatenation of the end segment, wherein (a), (b), (c) and (d) are repeated until it is determined that no path segments remain in the resource identifier; and responsive to determining no path segments remain in the resource identifier, returning an aggregated set of recorded permissions representing the complete set of effective permissions.

### CROSS-REFERENCE TO RELATED APPLICATION

The present application claims the benefit of U.S. Patent Provisional Application No. 63/740,129, titled “Hierarchical Cloud-Based Resource Identifier and Access Management System for Distributed Multi-tenant Data”, and filed Dec. 30, 2024, the contents of which are hereby incorporated by reference in their entirety.

### FIELD OF INVENTION

The present disclosure relates to authorization. Specifically, the present disclosure relates to authorization in a microservice environment, which may include a cloud environment.

### BACKGROUND

In a microservices architecture, different services often manage their own data, including permission information.

### SUMMARY

In general, an innovative aspect of the subject matter described in this disclosure may be implemented in methods that include receiving, using one or more processors, an authorization request, the authorization request including a first resource identifier including one or more path segments, the resource identifier uniquely identifying a set of resources in a microservice environment, the microservice environment including a plurality of microservices; processing, using the one or more processors, the resource identifier uniquely identifying the set of resources in the microservice environment to determine a complete set of effective permissions by: (a) determining whether a set of permissions is associated with the resource identifier is present in a resource access manager; (b) recording the set of permissions when the resource identifier is associated with the set of permissions in the resource access manager; (c) decatenating an end path segment from the resource identifier based on a delimiter; and (d) determining whether no path segments remain in the resource identifier after decatenation of the end segment, wherein (a), (b), (c) and (d) are repeated until it is determined that no path segments remain in the resource identifier; and responsive to determining no path segments remain in the resource identifier, returning an aggregated set of recorded permissions representing the complete set of effective permissions.

Some implementations may include one or more of the following features. For instance, the features may further include each microservice in the microservice environment being associated with its own set of resources, wherein each microservice generates its own resource identifiers, assigns the generated resource identifiers to that microservice's own set of resources, and maintains a record of the assignments. For instance, the features may further include that the resource identifiers generated, and assigned, by each microservice in the plurality of microservices use a common identification convention resulting in a common schema for resource identifiers generated across the plurality of microservices. For instance, the features may further include that the common identification convention includes a hierarchical containment model, wherein a first path segment to the left of the delimiter contains a resource identified by a second path segment to the right of the delimiter. For instance, the features may further include that the received authorization request is initiated by a first microservice in the microservice environment, and wherein the complete set of permissions includes a set of permissions associated with a user identified in the authorization request and at least one resource associated with the first microservice. For instance, the features may further include that the resource access manager is a centralized and single point of truth for permissions to access resources within the microservice environment. For instance, the features may further include that the resource access manager is sparse, wherein an entry therein represents a variance in a permission inheritance scheme. For instance, the features may further include the resource access manager including a sparse matrix. For instance, the features may further include the path segments being separated with an instance of a first delimiter, and the resource identifier including a prefix identifying a data-holding platform, wherein the prefix is separated from the one or path segments by a second delimiter. For instance, the features may further include the plurality of microservices including a first microservice and a second microservice, wherein the first microservice and second microservice are heterogenous with respect to one or more of a tenancy model and physical location handling.

According to yet other innovative aspects of the subject matter described in this disclosure, one or more systems comprising a processor; and a memory storing instructions that, when executed, cause the system to perform one of the methods described above.

Other implementations of one or more of these aspects include corresponding systems, apparatus, and computer programs, configured to perform the actions of the methods, encoded on computer storage devices.

The features and advantages described herein are not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example resource access management system in accordance with some implementations.

FIG. 2 is a block diagram illustrating an example server in accordance with some implementations.

FIG. 3 is a block diagram illustrating an example resource access manager in accordance with some implementations.

FIG. 4 illustrates an example resource identifier in accordance with some implementations.

FIG. 5 illustrates a portion of a sparse resource access management matrix in accordance with some implementations in tabular form.

FIG. 6 is block diagram of another example of a resource access management system in accordance with some implementations.

FIG. 7 is a flowchart of an example method for resource access management in accordance with some implementations.

FIG. 8 is a flowchart of another example method for resource access management in accordance with some implementations.

### DETAILED DESCRIPTION

In a microservices architecture, different services often manage their own data, including permission information. However, it may be necessary to aggregate and evaluate permissions across multiple services, e.g., to determine the effective permissions for a particular user or entity. These permissions are logically related but are physically distributed across various databases, data stores, or microservices.

This presents one or more challenges that may, at least partially, be overcome by the features and functionality described herein. A first example challenge may include fragmented permission data, as permissions are stored across multiple microservices, each responsible for managing a subset of the overall permission set. This fragmentation makes it difficult to efficiently gather all the necessary data to determine effective permissions for related entities.

A second example challenge may include performance and scalability. As the number of services and data sources grows, the overhead of searching and indexing across multiple services to retrieve all relevant permission records increases. This can result in higher latency and reduced system performance, especially in real-time or near-real-time systems.

A third example challenge may include consistency and accuracy. For example, ensuring that the data retrieved from various services is consistent and up to date is challenging. Differences in data retrieval times and/or service availability can lead to inconsistencies in the determined, effective permissions, which can have significant security implications.

A fourth example challenge may include security and compliance. Accurate and timely determination of permissions is critical for maintaining the security and compliance of the system. Inefficiencies or inaccuracies in the process may lead to unauthorized access or non-compliance with regulatory requirements.

The features and functionality described herein may provide an efficient method to minimize the number of records that need to be searched or indexed to determine the effective permissions for a single entity, thereby improving the functioning of one or more computers associated with the microservice architecture. The systems and methods described herein may (1) operate effectively within the constraints of a distributed microservices environment, where data is fragmented but logically related; and/or (2) scale as the number of services and the volume of data grows in accordance with some implementations.

Fragmentation of logically related data and scaling are problems that are particularly relevant in cloud-native environments where microservices are employed to enhance scalability, flexibility, and independent service development. However, the distributed nature of data and permissions across multiple services presents significant challenges in efficiently computing effective permissions, which is done to maintain secure, performant, and compliant systems.

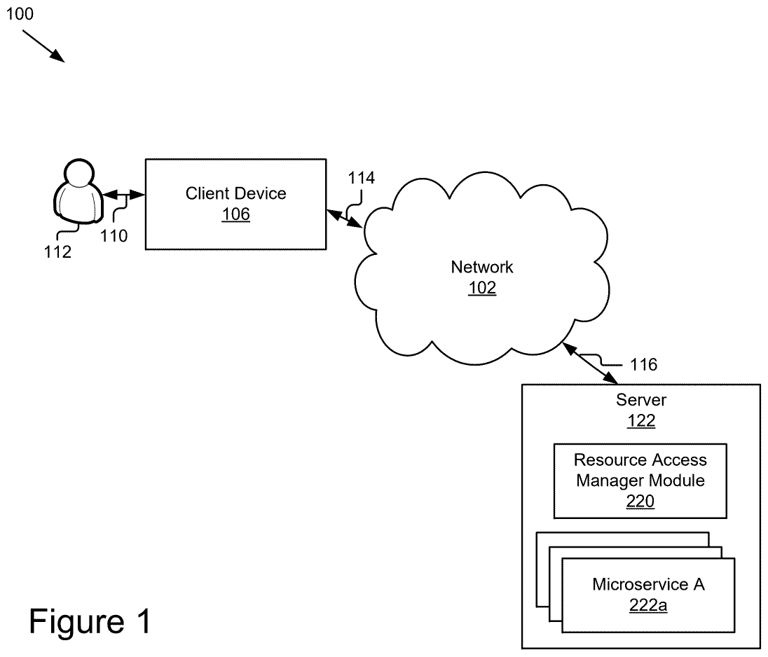

FIG. 1 is a block diagram illustrating an example system 100 for resource access management in accordance with some implementations. The illustrated system 100 includes a client device 106 and a server 122, which are communicatively coupled via a network 102 for interaction with one another. For example, the client devices 106 may be coupled to the network 102 via signal line 114. The server 122 may be coupled to the network 102 via signal line 116. In some implementations, the client device 106 may be accessed by a user 112 as illustrated by line 110.

The network 102 may include any number of networks and/or network types. For example, the network 102 may include, but is not limited to, one or more local area networks (LANs), wide area networks (WANs) (e.g., the Internet), virtual private networks (VPNs), mobile networks (e.g., the cellular network), wireless wide area network (WWANs), Wi-Fi networks, WiMAX® networks, Bluetooth® communication networks, peer-to-peer networks, other interconnected data paths across which multiple devices may communicate, various combinations thereof, etc. Data transmitted by the network 102 may include packetized data (e.g., Internet Protocol (IP) data packets) that is routed to designated computing devices coupled to the network 102. In some implementations, the network 102 may include a combination of wired and wireless (e.g., terrestrial or satellite-based transceivers) networking software and/or hardware that interconnects the computing devices of the system 100. For example, the network 102 may include packet-switching devices that route the data packets to the various computing devices based on information included in a header of the data packets.

The data exchanged over the network 102 can be represented using technologies and/or formats including the hypertext markup language (HTML), the extensible markup language (XML), JavaScript Object Notation (JSON), Binary JavaScript Object Notation, Comma Separated Values (CSV), etc. In addition, all or some of links can be encrypted using conventional encryption technologies, for example, the secure sockets layer (SSL), Secure Hypertext Transfer Protocol (HTTPS) and/or virtual private networks (VPNs) or Internet Protocol security (IPsec). In another implementation, the entities can use custom and/or dedicated data communications technologies instead of, or in addition to, the ones described above. Depending upon the implementation, the network 102 can also include links to other networks.

The client device 106 is a computing device having data processing and communication capabilities. While FIG. 1 illustrates one client device 106, the present specification applies to any system architecture having one or more client devices 106. In some implementations, a client device 106 may include a processor (e.g., virtual, physical, etc.), a memory, a power source, a network interface, and may include other components whether software or hardware, such as a display, graphics processor, wireless transceivers, input devices (e.g. mouse, keyboard, camera, sensors, etc.) firmware, operating systems, drivers, various physical connection interfaces (e.g., USB, HDMI, etc.). The client devices 106 may couple to and communicate with one another and the other entities (e.g. server 122) of the system 100 via the network 102 using a wireless and/or wired connection.

Examples of client devices 106 may include, but are not limited to, mobile phones (e.g., feature phones, smart phones, etc.), tablets, laptops, desktops, netbooks, server appliances, servers, virtual machines, TVs, set-top boxes, media streaming devices, portable media players, navigation devices, personal digital assistants, etc. While one client device 106 is depicted in FIG. 1 for clarity and convenience, the system 100 may include any number of client devices 106. In addition, the any number of client devices 106 may be the same or different types of computing devices. In the depicted implementation, the user 112 uses the client device 106 to access and use one or more microservices 222a-222n.

The server 122 may include one or more computing devices having data processing, storing, and communication capabilities. For example, the server 122 may include one or more hardware servers, server arrays, storage devices, systems, etc. In some implementations, the server 122 is distributed or cloud-based. For example, in some implementations, the server 122 may include one or more virtual servers, which operate in a host server environment and access the physical hardware of the host server including, for example, a processor, memory, storage, network interfaces, etc., via an abstraction layer (e.g., a virtual machine manager). For example, the microservices 222a-222n may run on virtual machines in the server 122. As another example, in some implementations, the server 122 may include one or more containers (not illustrated), which operate in a host server environment and access the physical hardware of the host server including, for example, a processor, memory, storage, network interfaces, etc., via an abstraction layer (e.g., a virtual machine manager). For example, the microservices 222a-222n may each run in individual containers (not shown), e.g., using Docker, across one or more hardware servers.

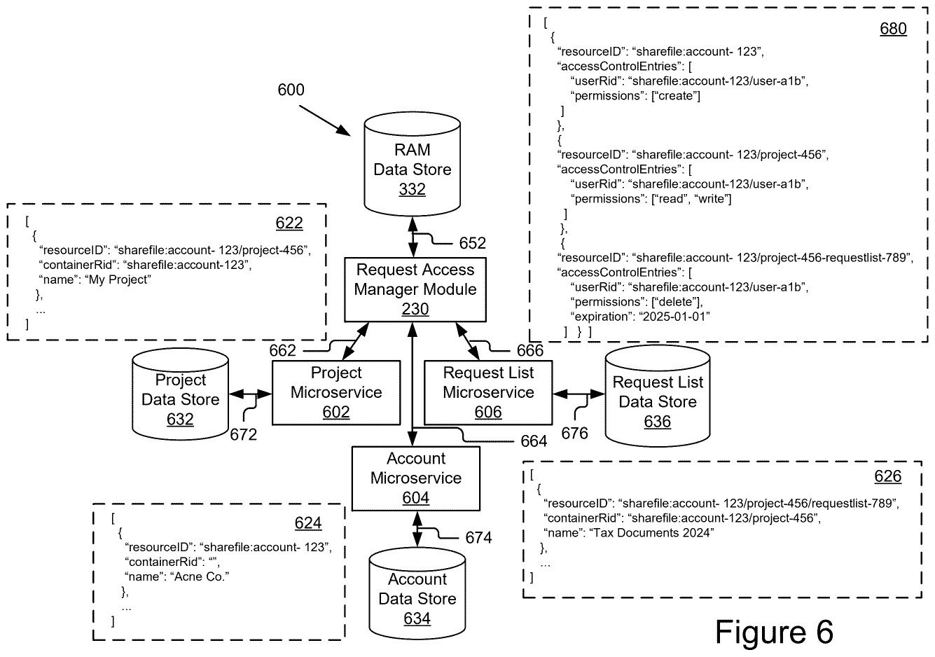

While three microservice instances are illustrated in FIG. 1, it should be recognized that description herein applies to a system including one or more microservices 222. The service provided by each microservice individually or collectively may vary based on the implementation and use case. For example, referring now to FIG. 6, the microservice 122a may correspond to the project microservice 602, the microservice 122b may correspond to an account microservice 604, and the microservice 122c may correspond to the request list microservice 636.

In one implementation, the server 122 includes the resource access manager (RAM) 220 module. The RAM 220 module may be storable in a memory and executable by a processor of a server 122.

It should be understood that the system 100 illustrated in FIG. 1 is representative of an example resource access management system according to some implementations and that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the system 100 may be integrated into a single computing device or system or additional computing devices or systems may be included. For example, in one implementation, the illustrated microservices 222a-222n, or a subset thereof, may not be present on the same server 122 as the resource access manager module 220 and/or as one another depending on the implementation. As another example, additional components such as load balancers, gateways, etc. may be present.

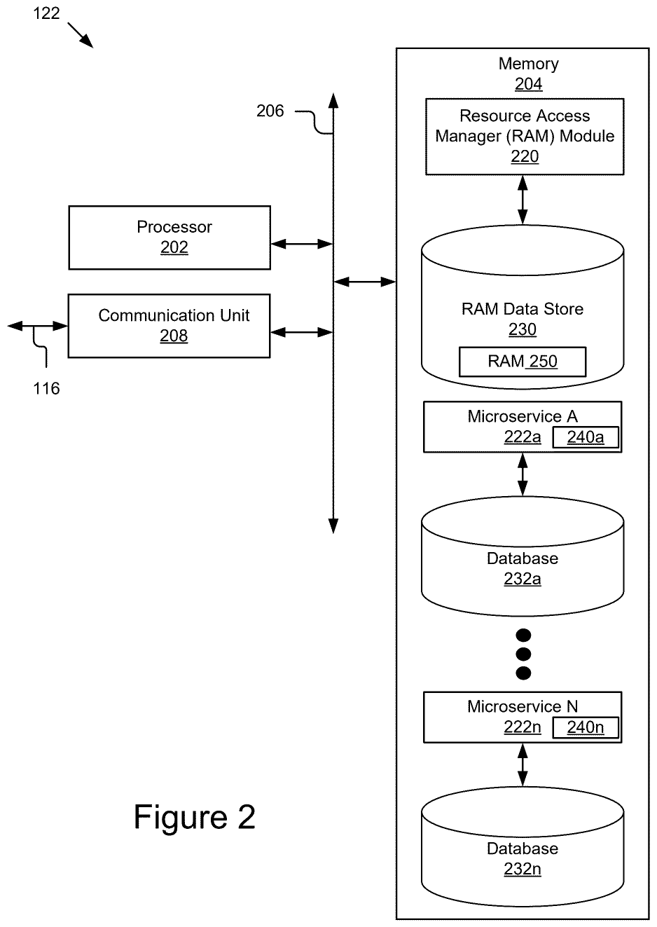

FIG. 2 is a block diagram of an example server 122 in accordance with some implementations. The server 122, as illustrated, may include a processor 202, a memory 204 and a communication unit 208, which may be communicatively coupled by a communications bus 206. The server 122 depicted in FIG. 2 is provided by way of example and it should be understood that it may take other forms and include additional or fewer components without departing from the scope of the present disclosure. For example, while not shown, the server 122 may include input and output devices (e.g., one or more of a display, a keyboard, a mouse, touch screen, speakers, microphone, camera, sensors, etc.), various operating systems, sensors, additional processors, and other physical configurations.

The processor 202 may execute code, routines and software instructions by performing various input/output, logical, and/or mathematical operations. The processor 202 have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual and may include a single core or plurality of processing units and/or cores. In some implementations, the processor 202 may be capable of generating and providing electronic display signals to a display device (not shown), supporting the display of images, capturing and transmitting images, performing complex tasks including various types of feature extraction and sampling, etc. In some implementations, the processor 202 may be coupled to the memory 204 via the bus 206 to access data and instructions therefrom and store data therein. The bus 206 may couple the processor 202 to the other components of the data server 122 including, for example, the memory 204 and communication unit 208.

The memory 204 may store and provide access to data to the other components of the server 122. In some implementations, the memory 204 may store instructions and/or data that may be executed by the processor 202. For example, in the illustrated implementation, the memory 204 may store the resource access management module 220. The memory 204 is also capable of storing other instructions and data, including, for example, an operating system, hardware drivers, other software applications, databases, etc. The memory 204 may be coupled to the bus 206 for communication with the processor 202 and the other components of the server 122.

The memory 204 includes a non-transitory computer-usable (e.g., readable, writeable, etc.) medium, which can be any apparatus or device that can contain, store, communicate, propagate or transport instructions, data, computer programs, software, code, routines, etc., for processing by or in connection with the processor 202. In some implementations, the memory 204 may include one or more of volatile memory and non-volatile memory. For example, the memory 204 may include, but is not limited, to one or more of a dynamic random access memory (DRAM) device, a static random access memory (SRAM) device, a discrete memory device (e.g., a PROM, FPROM, ROM), a hard disk drive (HDD), an optical disk drive (CD, DVD, Blu-ray™, etc.). It should be understood that the memory 204 may be a single device or may include multiple types of devices and configurations. For example, in one implementation, the memory 204 may include a HDD and a random access memory, and portions of the data stored in the HDD may be read into random access memory for processing by the processor 202.

In one implementation, the memory 204 includes a resource access manager (RAM) data store 230 for storing a resource access management structure 250, such as a sparse matrix, which is described below in greater detail below in accordance with some implementations. As described herein, the resource access manager module 220 may address one or more challenges in a distributed/cloud microservice architecture. Thus, the system 100 includes one or more microservices. For clarity and convenience, the microservice architecture illustrated herein is simplified and omits various components that may be present in a distributed cloud environment, e.g., a load balancer, Docker, various containers for each microservice instance, etc. FIG. 2 illustrates microservice A 222a through microservice N 222n, but any number of microservices may be present without departing from the description herein. For example, the illustrated microservices A-N 222a-222n may be omitted from the server 122 and run as separate cloud instances, e.g., on other servers (not shown). It should also be recognized that the microservices 222a through 222n may represent different microservices, multiple instances of the same microservice, or a combination thereof.

In some implementations, each microservice (e.g. microservice A 222a and microservice 222n) is associated with its own set of resources (e.g., in some implementations, each microservice may manage its own database illustrated by 232a and 232n, respectively). In some implementations, each microservice may request and receive, from the RAM module 220, a set of permissions associated with a user and with respect to resources or a portion thereof.

The bus 206 can include a communication bus for transferring data between components of a server 122 and/or between computing devices (e.g. between the server 122 and the client device 106), a network bus system including the network 102 or portions thereof, a processor mesh, a combination thereof, etc. In some implementations, the RAM module 220, its sub-components and various other software operating on the server 122 (e.g., an operating system, etc.) may cooperate and communicate via a software communication mechanism implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 208 may include one or more interface devices (I/F) for wired and/or wireless connectivity with the network 102. For instance, the communication unit 208 may include, but is not limited to, CAT-type interfaces; wireless transceivers for sending and receiving signals using radio transceivers (4G, 3G, 2G, etc.) for communication with the mobile network, and radio transceivers for Wi-Fi™ and close-proximity (e.g., Bluetooth®, NFC, etc.) connectivity, etc. ; USB interfaces; various combinations thereof; etc. In some implementations, the communication unit 208 can link the processor 202 to the network 102, which may in turn be coupled to other processing systems. The communication unit 208 can provide other connections to the network 102 and to other entities of the system 100 using various network communication protocols.

### Example Resource Identifier (RID) Module 240

Still referring to FIG. 2, in some implementations, a microservice 222 includes a RID module 240, which generates and assigns a resource identifier to the resources generated and/or maintained by that microservice. For example, in the illustrated implementation, microservice A 222a includes a RID module instance 240a and microservice N 222n includes a RID module instance 240n. In some implementation, the RIDs assigned by various RID modules 240 associated with their various, respective microservices use a common identification convention, which may also be referred to as a schema, structure, model, pattern, or syntax, thereby ensuring the microservices 222a-222n associated with, and using, the resource access management system 100 and methods herein are using the same standard for identifying resources.

A RID module instance 240 or its components may include software or routines for providing the features and functionalities described herein. In some implementations, the RID module instance 240 or its components include a set of instructions executable by a processor 202. In some implementations, the instructions are stored in a memory 204 and are accessible and executable by a processor 202. In some implementations, the RID module instance 240 or its components are adapted for cooperation and communication with a processor 202 and other components of the computing device 200 and/or system 100. For example, RID module instance 240 may be communicatively coupled to provide a generated and assigned resource identifier and/or one or more permissions associated with that resource to the RAM module 220 and/or RAM data store 250 for storage and use as described herein.

In some implementations, the RID module 240 applies a method for identifying cloud-based resources with a resource identifier (RID) using a hierarchical containment model, employing a Universal Resource Indicator (URI) style syntax. In some implementations, the RID generated by a RID module 240 has a structure. For example, in some implementations, an RID follows a pattern such as:

system:resourcetype-shortid/resourcetype-shortid/. . .

Where “system” is a first RID portion that denotes the data-holding platform, “resourcetype” is a second RID portion that describes the data schema, and “shortid” is a third RID portion that is a collection-specific identifier. While the foregoing example illustrates an RID including the data-holding platform and two path segments, separated by a forward slash “/”, the foregoing is merely an example and one or more segments may be generated and assigned. In some implementations, the RID includes a path, and each segment in that path represents the parent container for the child resource(s) identified in the segment to the right of it. The presence of the ellipsis “. . . ” in the preceding example illustrates that the identification convention is extensible to any number of hierarchical layers of “containers.” In some implementations, each path segment, which may also be referred to simply as a “segment,” includes a resource type component and an identifier component, which may be separated by a particular delimiter (e.g., a “-” hyphen as used in the examples herein).

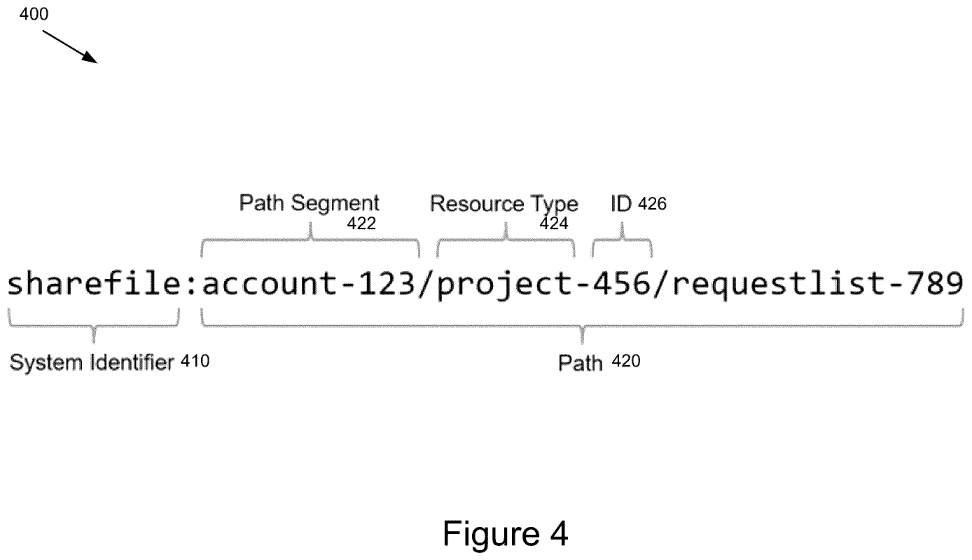

Now referring to FIG. 4, an example RID 400 is illustrated in accordance with some implementations. In the illustrated example RID 400, “sharefile:account-123” is the parent container for sharefile:account-123/project-456. “sharefile:account-123/project-456” is, in turn, the parent “container” for “sharefile:account-123/project-456/requestlist-789.” It should be understood that the foregoing are merely example structures and hierarchy provided for clarity and convenience and that others exist and may be used without departing from the description herein. For example, it should be recognized that different implementations may include other or different data-holding platforms than “sharefile,” other or additional resource types, and/or other or additional hierarchical taxonomies for resource “containers,” etc. As another example, still referring to FIG. 4, different delimiters may be used (e.g., a delimiter other than the colon “:” between the system identifier 410, which may also occasionally be referred to a data-holding platform segment, and the path 420 segment, and/or a delimiter other than a forward-slash “/” between one or more segments 422, 424, 426, etc. of the path 420 may be used without departing from the description herein.

In some implementations, a RID generated and assigned by a RID module 240 is unique and immutable. For example, in some implementations, a RID is unique to its associated microservice and, more generally, within the system 100, so no two resources can be referenced by the same RID. Since RIDs at various levels of the hierarchy are potentially stored in many different data stores within the distributed system 100, changing or updating a RID is a complex problem. Because of this complexity, RIDs are immutable once generated and assigned by the RID module 240 according to some implementations. In some implementations, this pattern/RID structure at least partially addresses challenges associated with consistency and accuracy by ensuring that all participating microservices (e.g., microservices A-N 222a-n) use the same standard/convention for identification or resources.

### Example Resource Access Manager (RAM) Module 220

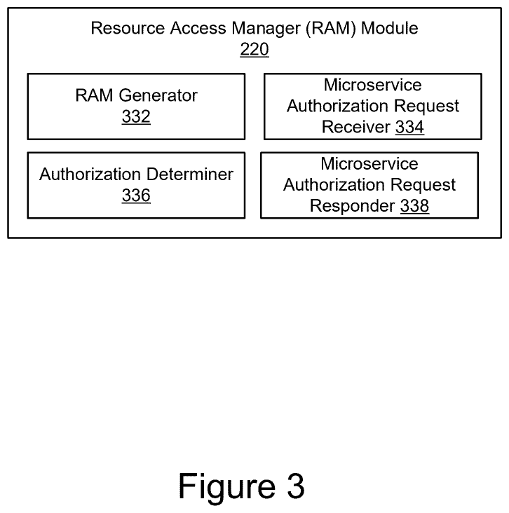

Referring now to FIG. 3, the RAM module 220 is shown in more detail in accordance with some implementations. In the illustrated implementation, the RAM 220 includes a RAM generator 332, a microservice authorization request receiver 334, an authorization determiner 336, and a microservice authorization request responder 338. In some implementations, the RAM module 220 is itself a microservice. The components (e.g. 332-338) or their subcomponents may include software or routines for providing the features and functionalities described herein. In some implementations, the component(s), or subcomponent(s), which comprise the RAM module 220, include a set of instructions executable by a processor 202. In some implementations, the instructions are stored in a memory 204 and are accessible and executable by a processor 202. In some implementations, the component(s), or subcomponent(s) thereof, are adapted for cooperation and communication with a processor 202 and other components of the computing device 200 and/or system 100. For example, RAM module 220 may be communicatively coupled to receive one or more authorization requests from microservices A-N 222a-n and respond to each request with a set of access permissions.

In some implementations, the RAM generator 332 is communicatively coupled to obtain RIDs and other permissions data from the various microservices (e.g., microservices A-N 222a-n). Examples of other permissions data include, but are not necessarily limited to, information describing the authorized user(s) of each resource, the types of permission(s) of those one or more users with respect to each resource (e.g., read, write, create, delete, etc.), and any relevant expiration dates for a particular user and/or permission type.

The RAM generator 332 obtains RIDs and other permission data from the various, distributed microservices (e.g., microservices A-N 222a-n) and populates a sparse matrix occasionally referred to as the resource access manager (RAM). The RAM maps RIDs to user identities. In some implementations, a user identity may also be a RID, in some implementations, and be associated with permissions. In some implementations, the RAM is stored in the memory 204 (e.g., the RAM data store 230) and accessible by the RAM module 220 and/or one or more of its components 332/334/336/338.

In some implementations, the RAM, and/or a RID, therein represents a hierarchical containment model. For example, in some implementations, the RID represents a model analogous to a folder in a filesystem, where operations on a parent container apply to child containers, ensuring consistent data management. The RID may thereby facilitate the ability to handle this data management in a complex and distributed environment.

In some implementations, the RAM and RIDs facilitate hybrid tenancy and/or physical location handling. In some implementations, the RID provides extreme flexibility in resource data storage and tenancy. For example, in some implementations, the resource type(s) identified in the path segment of a RID are owned by a single microservice, e.g., “sharefile” in the example of FIG. 4. A microservice may own one or more resource types, and the underlying physical storage thereof may be in the cloud, on-premises, or a hybrid model. In some implementations, the RID convention described herein, in addition to facilitating flexibility of physical storage models and/or in addition thereto, may facilitate different tenancy models: single tenant and multi-tenant, hybrid single & multi-tenant. The ability to support multiple, potentially heterogenous, physical storage and tenancy models may at least partially address one or more predictable data isolation needs.

In some implementations, the Resource Access Manager (RAM) is a sparse matrix (e.g., stored in the RAM data store 230) that maps RIDs to user identities (which are also RIDs) and their permissions (e.g. read, write, share, etc.). In some implementations, permissions are inherited. In those implementations, there is no requirement that each RID have an explicit entry in the RAM. In some implementations, entries are only required when the permissions for a specific RID are different from the inherited permission(s).

In some implementations, the RAM may directly addresses the challenge of fragmented permission data by centralizing the permission data where it can be consumed by the other microservices. It may also addresses security and compliance issues by acting as a single source of truth and compliance for permission data. For example, referring now to FIG. 6, a high-level diagram of a distributed microservice system 600 and a RAM module 220 and RAM data store 332 acting as the single source of truth for sets of effective permissions is illustrated in accordance with some implementations.

In the illustrated system 600, the account microservice 604 is associated with the account data store 634 and assigns RIDs to resources associated with one or more of the account microservice 604 and the account data store 634. For example, the account microservice 604 assigns the RID “sharefile:account-123” to an account named “Acne Co.” The account microservice 604 is communicatively coupled to the request access manager module 230 as illustrated by line 664. In some implementations, the request access manager module 230 stores a set of permissions associated with a user “user-a1b” and “account-123,” i.e., a create permission, as illustrated in 680. The project microservice 602 is associated with the project data store 632 and assigns RIDs to resources associated with one or more of the project microservice 602 and the project data store 632. For example, the project microservice 602 assigns the RID “sharefile:account-123/project-456” to a project named “My Project,” which is associated with the “Acne Co.” account as indicated by the “account-123” path segment preceding the “project 456” path segment. The project microservice 602 is communicatively coupled to the request access manager module 230 as illustrated by line 662. In some implementations, the request access manager module 230 stores a set of permissions associated with the user “user-a1b” and “project-456,” i.e., read, and write permission as illustrated in 680. The request list microservice 606 is associated with the request list data store 636 and assigns RIDs to resources associated with one or more of the request list microservice 606 and the request list data store 636. For example, the request list microservice 606 assigns the RID “sharefile:account-123/project-456/requestlist-789” to a list named “Tax Documents 2024,” which is associated with/contained within “My Project” as indicated by the “project-456” path segment that precedes the “requestlist-789” path segment, where “My Project” identified as “project-456” is associated with/contained within the “Acne Co.” account, as indicated by the “account-123” path segment preceding the “project-456” path segment. The request list microservice 606 is communicatively coupled to the request access manager module 230 as illustrated by line 662. In some implementations, the request access manager module 230 stores a set of permissions associated with the user “user-a1b” and “requestlist-789,” i.e., a delete permission as illustrated in 680.

Assume that user “user-a1b” is requesting to take an action with respect to “Tax Documents 2024,” which is associated with the “sharefile:account-123/project-456/requestlist-789.” The RAM module 230 determines that user “user-a1b” has a delete permission specific to that request list, which expires on “2025, Jan. 1,” has read and write privileges for “My Project” to which “Tax Documents 2024” belongs, and has a create privilege for the “Acne Co.” account to which “My Project” belongs. Therefore, user “user-a1b” has a complete set of effective permissions of create, read, write, and delete with respect to “Tax Documents 2024.”

In some implementations, permissions assigned to an RID are inherited by child resources unless overridden, thereby allowing for efficient access control. For example, referring to the preceding example, the create, read, and write permissions for user “user-a1b” with respect to “Tax Documents 2024” are inherited by virtue of the hierarchy and permissions associated with the bolded path segments or portions thereof “sharefile:account-123/project-456/requestlist-789.”

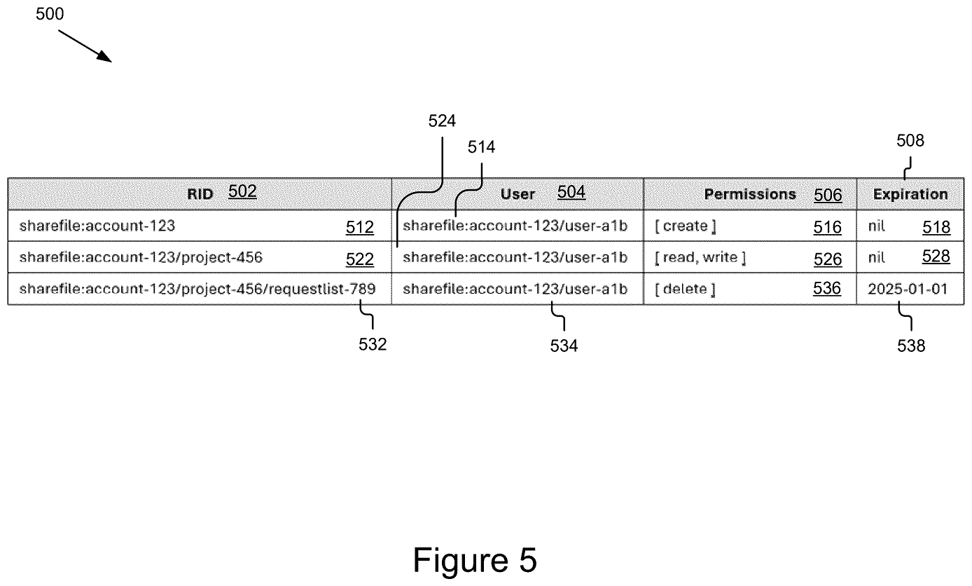

In some implementations, one or more permissions can include an expiration time, after which that access is automatically revoked by the RAM module 220, enhancing security and control over resource access across known as well anonymous users accessing the system. Referring now to FIG. 5, an example of a RAM sparse matrix is illustrated as a table 500. It should be understood that, while the RAM 500 is illustrated in tabular form for clarity and convenience, the RAM may not necessarily be a table and other schemas may be used without departing from the disclosure herein.

In some implementations, the basis of an entry in the sparse matrix is to maintain the data necessary to indicate a variance in the permission inheritance scheme. The example table 500 is “sparse” because second row does not need to contain “create” because that permission is inherited from the first row. Similarly, the third row does not need to contain create, read, or write because those permissions are inherited from cell 516 in the first row and cell 526 in the second row. The illustrated RAM table 500 is also sparse because no entry is required to indicate that User sharefile:account-123/user-a1b has create, read, write, and delete permissions for the RID sharefile:account-123/project-456/requestlist-789/file-2c3. Those permissions for that example RID, which is not explicitly present in RAM 500, are inherited and determinable (e.g., by the authorization determiner 336 described below) from the RAM 500 entries illustrated.

The microservice authorization request receiver 334 receives requests from a microservice (e.g., a microservice A 222a or microservice N 222n) for authorization (e.g., for a set of effective permissions for an identified resource and user), the authorization determiner 336 uses information from the request (e.g., a RID associated with the identified resource and a RID associated with the identified user) and in the RAM data store 230 to determine a set of effective permissions, and the microservice authorization request responder 338 provides a response to the microservice's request, e.g., by providing the set of effective permissions for a resource and a user associated with request.

The authorization determiner 336 determines the set of effective permissions. In some implementations, the authorization determiner 336 determines the set of effective permissions using the RAM and the following algorithm:
1) Given a User and a RID, look for a matching entry.
   a) If found, record the permissions.
2) Remove ending segment of the RID, look for a matching entry.
   a) If found, add the permissions to those already recorded.
3) Repeat step 2 until no segments remain.
4) If any permissions have been recorded, then the collection represents the effective permissions.
5) If no permissions have been recorded, then the User has no effective permissions for the RID.

For example, still referring to the example portion of RAM table 500 illustrated in FIG. 5, assume that an authorization request is received from a “sharefile” microservice and the request includes an identification of a user “sharefile:account-123/user-a1b” and the RID “sharefile:account-123/project-456/requestlist-789/file-2c3.” The authorization determiner 336 looks for any matching entry, as per step (1) of the example algorithm above, but there is no exact match to that RID (i.e., “sharefile:account-123/project-456/requestlist-789/file-2c3”) for that user (i.e., user “sharefile:account-123/user-a1b”) in RAM 500, so the authorization removes the ending segment of the RID, as per step (2), which may also be referred to as “de-catenating” or “truncating” the RID. The end segment may be based on a delimiter, i.e., the portion of the RID beyond the last (i.e., right-most) instance of the “/” delimiter in this example. In decatenating the ending segment, the authorization determiner 336 has generated a modified and intermediary version of the received RID. Specifically, the modified RID at this point in the example is “sharefile:account-123/project-456/requestlist-789.” The authorization determiner 336 performs another look-up in the RAM 500 sparse matrix and finds that this modified, or “first intermediary,” RID is present, as illustrated in cell 532. This first intermediary RID is associated with the user identified in the request, as illustrated by cell 534, and the modified RID is associated with a “[delete]” permission, as illustrated in cell 536. As per step 2(a) of the example algorithm above, the authorization determiner 336 records the “[delete]” permission if prior to the Jan. 1, 2025 expiration indicated at cell 538, then, as per step (3) repeats step (2) of the above example algorithm, removes the ending segment of the first intermediary RID, thereby generating a newly updated, modified, or “second intermediary,” RID, i.e., “sharefile:account-123/project-456” in this example. That second intermediary RID is associated with the “[read, write]” permissions, as illustrated in cell 526. The authorization determiner 336 records the read and write permissions, then removes the ending segment, as determined by the last “/” delimiter, thereby generating a newly updated, modified, or “third intermediary” RID, i.e., “sharefile:account-123,” which is associated with the “[create]” permission, as illustrated in cell 516. The authorization determiner 336 records the create permission and determines that there are no ending segments left to remove, e.g., as determined by the absence of a “/” delimiter. In other words the “third intermediary RID” in this example is a “final” RID, so the authorization determiner 336 proceeds from step (3) to step (4) of the above example algorithm. In some implementations, the authorization determiner 336 determines the set of effective permissions as the aggregated collection of recorded permissions, i.e., delete, read, write, and create when prior to 2025-Jan 1 or read, write, and create when on or after 2025-Jan 1, and the set of effective permissions may be returned to the requesting microservice in a response generated and sent by the microservice authorization request responder 338.

It should be the foregoing algorithm based on the RAM sparse matrix may provide a predictable level of performance and scalability.

In some implementations, the RAM facilitates an enhanced sharing mechanism in a SaaS environment through management simplification and optimization. This can be accomplished because the RAM is the singular authority for all resource permissions regardless of microservice, type, or containment. In some implementations, the RAM enables dynamic permission allocation. For example, users can be invited with time-bound, scope-specific permissions, offering control and flexibility. In some implementations, the sharing mechanism in the RAM enhances security and compliance, ensuring precise access control and data protection.

### Example Methods

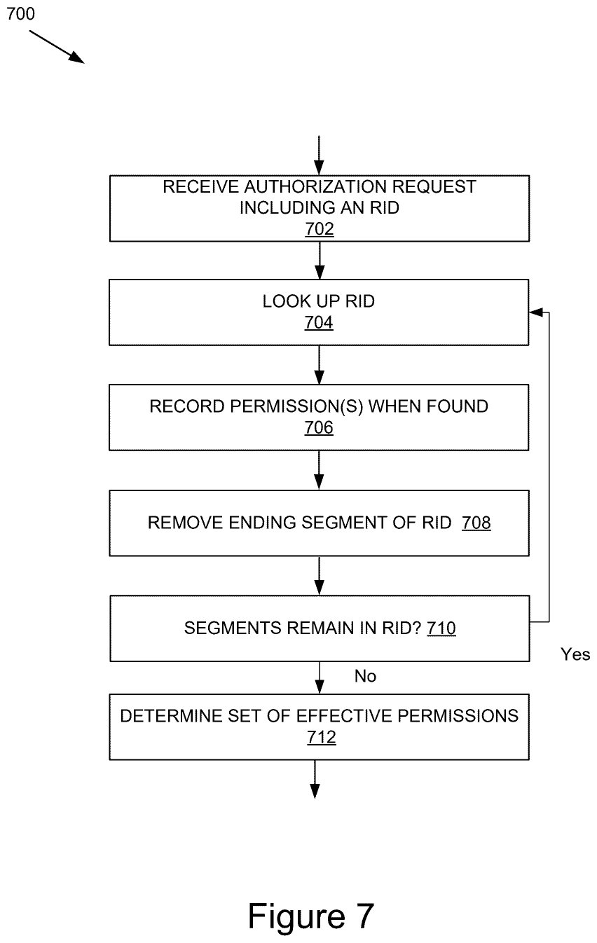

FIG. 7 depicts an example method 700 that may performed by the system described above in reference to FIGS. 1-3 and 6 in accordance with some implementations. The method 700 begins at block 702. At block 702, the authorization determiner 336 receives an authorization request including an RID. At block 704, the authorization determiner 336 looks up the RID. At block 706, the authorization determiner 336 determines and records a set of permissions associated with the RID looked up at block 704 when a set of one or more associated permissions is present. At block 708, the authorization determiner 336 removes an ending segment of the RID looked up at block 704, thereby generating a modified resource identifier. At block 710, the authorization determiner 336 determines whether any segments remain in the modified resource identifier generated at block 708. When the authorization determiner 336 determines that one or more segments remain in the modified RID (710-Yes), the method 700 returns to block 704, where the modified RID is looked up and blocks 704-710 are repeated until the authorization determiner 336 determines no segments remain in the modified resource identifier generated at block 708 (710-No), and the authorization determiner 336 determines a set of effective permissions as the aggregation of the permission(s) recorded across the one or more instances of block 706.

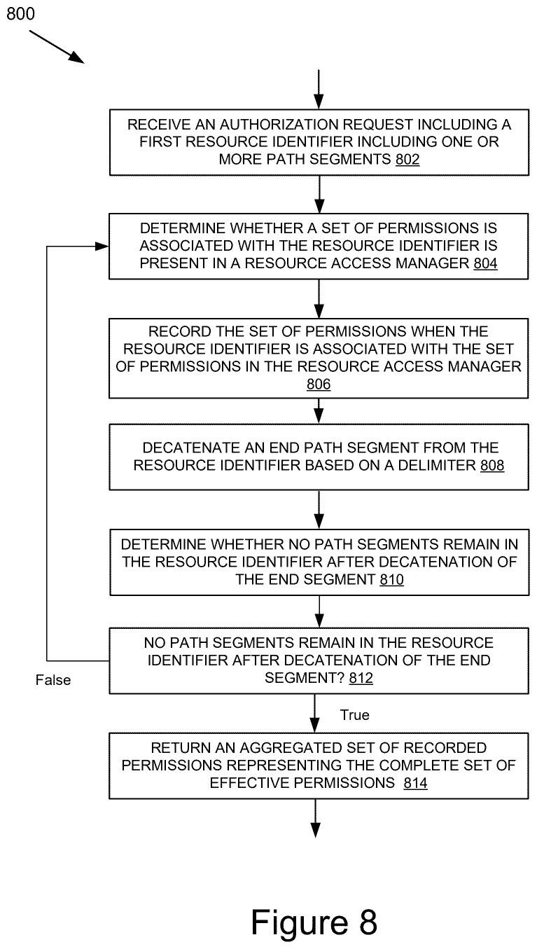

FIG. 8 depicts another example method 800 that may be performed by the system described above in reference to FIGS. 1-3 and 6 in accordance with some implementations. At block 802, the microservice authorization request receiver 334 receives an authorization request, the authorization request including a first resource identifier including one or more path segments. In some implementations, the resource identifier uniquely identifies a set of resources in a microservice environment, the microservice environment including a plurality of microservices. The authorization determiner 336 processes the resource identifier uniquely identifying the set of resources in the microservice environment to determine a complete set of effective permissions. At block 804, the authorization determiner 336 determines whether a set of permissions is associated with the resource identifier is present in a resource access manager. At block 806, the authorization determiner 336 records the set of permissions when the resource identifier is associated with the set of permissions in the resource access manager. At block 808, the authorization determiner 336 decatenates an end path segment from the resource identifier based on a delimiter. At block 810, the authorization determiner 336 determines whether no path segments remain in the resource identifier after decatenation of the end segment. When one or more path segments remain (812-False), the method 800 continues at block 804, and blocks 804-810 are repeated until no path segments remain in the resource identifier (812-True). At block 814, the microservice authorization responder 338 returns aggregated set of recorded permissions representing the complete set of effective permissions and the method 800 ends.

### Other Considerations

The above-described examples are provided by way of illustration and not limitation and that numerous additional use cases are contemplated and encompassed by the present disclosure. In the above description, for purposes of explanation, numerous specific details are set forth to provide a thorough understanding of the present disclosure. However, the technology described herein may be practiced without these specific details. Further, various systems, devices, and structures are shown in block diagram form to avoid obscuring the description. For instance, various implementations are described as having particular hardware, software, and user interfaces. However, the present disclosure applies to any type of computing device that can receive data and commands, and to any peripheral devices providing services.

Reference in the specification to “one implementation” or “an implementation” or “some implementations” means that a particular feature, structure, or characteristic described in connection with the implementation is included in at least one implementation. The appearances of the phrase “in some implementations” in various places in the specification are not necessarily all referring to the same implementations.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As should be understood by those familiar with art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies, engines, and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
receiving, using one or more processors, an authorization request, the authorization request including a resource identifier including one or more path segments, the resource identifier uniquely identifying a set of resources in a microservice environment, the microservice environment including a plurality of microservices;
processing, using the one or more processors, the resource identifier uniquely identifying the set of resources in the microservice environment to determine a complete set of effective permissions by:
(a) determining whether a set of permissions is associated with the resource identifier is present in a resource access manager;
(b) recording the set of permissions when the resource identifier is associated with the set of permissions in the resource access manager;
(c) decatenating an end path segment from the resource identifier based on a delimiter; and
(d) determining whether no path segments remain in the resource identifier after decatenation of the end path segment,
wherein (a), (b), (c) and (d) are repeated until it is determined that no path segments remain in the resource identifier; and
responsive to determining no path segments remain in the resource identifier, returning an aggregated set of recorded permissions representing the complete set of effective permissions.

2. The computer-implemented method of claim 1, wherein each microservice in the microservice environment is associated with its own set of resources, wherein each microservice generates its own resource identifiers, assigns the generated resource identifiers to that microservice's own set of resources, and maintains a record of the assignments.

3. The computer-implemented method of claim 2, wherein the resource identifiers generated, and assigned, by each microservice in the plurality of microservices use a common identification convention resulting in a common schema for resource identifiers generated across the plurality of microservices.

4. The computer-implemented method of claim 3, wherein the common identification convention includes a hierarchical containment model, wherein a first path segment left of the delimiter contains a resource identified by a second path segment right of the delimiter.

5. The computer-implemented method of claim 1, wherein the received authorization request is initiated by a first microservice in the microservice environment, and wherein the complete set of permissions includes a set of permissions associated with a user identified in the authorization request and at least one resource associated with the first microservice.

6. The computer-implemented method of claim 1, wherein the resource access manager is a centralized and single point of truth for permissions to access resources within the microservice environment.

7. The computer-implemented method of claim 1, wherein the resource access manager is sparse, wherein an entry therein represents a variance in a permission inheritance scheme.

8. The computer-implemented method of claim 1, wherein the resource access manager includes a sparse matrix.

9. The computer-implemented method of claim 1, wherein path segments separated with an instance of a first delimiter, and the resource identifier includes a prefix identifying a data-holding platform, the prefix separated from the one or path segments by a second delimiter.

10. The computer-implemented method of claim 1, wherein the plurality of microservices includes a first microservice and a second microservice, wherein the first microservice and second microservice are heterogenous with respect to one or more of a tenancy model and physical location handling.

11. A system comprising:
one or more processors; and
a memory storing instructions that, when executed by the one or more processors, cause the system to:
receive an authorization request, the authorization request including a resource identifier including one or more path segments, the resource identifier uniquely identifying a set of resources in a microservice environment, the microservice environment including a plurality of microservices;
process the resource identifier uniquely identifying the set of resources in the microservice environment to determine a complete set of effective permissions by:
(a) determining whether a set of permissions is associated with the resource identifier is present in a resource access manager;
(b) recording the set of permissions when the resource identifier is associated with the set of permissions in the resource access manager;
(c) decatenating an end path segment from the resource identifier based on a delimiter; and
(d) determining whether no path segments remain in the resource identifier after decatenation of the end path segment,
wherein (a), (b), (c) and (d) are repeated until it is determined that no path segments remain in the resource identifier; and
responsive to determining no path segments remain in the resource identifier, return an aggregated set of recorded permissions representing the complete set of effective permissions.

12. The system of claim 11, wherein each microservice in the microservice environment is associated with its own set of resources, wherein each microservice generates its own resource identifiers, assigns the generated resource identifiers to that microservice's own set of resources, and maintains a record of the assignments.

13. The system of claim 12, wherein the resource identifiers generated, and assigned, by each microservice in the plurality of microservices use a common identification convention resulting in a common schema for resource identifiers generated across the plurality of microservices.

14. The system of claim 13, wherein the common identification convention includes a hierarchical containment model, wherein a first path segment left of the delimiter contains a resource identified by a second path segment right of the delimiter.

15. The system of claim 11, wherein the received authorization request is initiated by a first microservice in the microservice environment, and wherein the complete set of permissions includes a set of permissions associated with a user identified in the authorization request and at least one resource associated with the first microservice.

16. The system of claim 11, wherein the resource access manager is a centralized and single point of truth for permissions to access resources within the microservice environment.

17. The system of claim 11, wherein the resource access manager is sparse, wherein an entry therein represents a variance in a permission inheritance scheme.

18. The system of claim 11, wherein the resource access manager includes a sparse matrix.

19. The system of claim 11, wherein path segments separated with an instance of a first delimiter, and the resource identifier includes a prefix identifying a data-holding platform, the prefix separated from the one or path segments by a second delimiter.

20. The system of claim 11, wherein the plurality of microservices includes a first microservice and a second microservice, wherein the first microservice and second microservice are heterogenous with respect to one or more of a tenancy model and physical location handling.
